(19) United States
(12) Patent Application Publication
(10) Pub. No.: US 2012/0196186 A1
(43) Pub. Date: Aug. 2, 2012

(54) ELECTRODE MATERIAL WITH CORE-SHELL STRUCTURE

(75) Inventor: Monique N. Richard, Ann Arbor, MI (US)

(73) Assignee: Toyota Motor Engineering & Manufacturing North America, Inc., Erlanger, KY (US)

(21) Appl. No.: 13/018,989

(22) Filed: Feb. 1, 2011

(51) Int. Cl. H01M 4/58; H01M 4/00

(52) U.S. Cl. 429/231.6; 429/209; 429/231.95; 429/231.9; 429/218.1

(57) ABSTRACT

The present invention discloses a composite material having an ionic and electronic conductive outer shell with an active material inner core located within the outer shell. The outer shell can be impervious to a gas and a liquid, and in some instances contains a compound such as SiO₂, Al₂O₃, P₂S₅, and Li₂S. The composite material may or may not have a secondary outer shell that is located on an exterior of the outer shell. The outer shell and/or the secondary outer shell can contain a compound such as SiO₂, Al₂O₃, P₂S₅, and/or Li₂S. In some instances, the outer shell contains Li₂S:P₂S₅, while in other instances, the outer shell contains LiPON. In addition, the inner core can contain an element such as lithium, sodium, potassium, and the like.

### FIELD OF THE INVENTION

The present invention is related to a composite material, and in particular to a composite material in the form of a composite particle having an active material inner core within an ionic and electronic conductive outer shell.

### BACKGROUND OF THE INVENTION

Energy requirements for batteries are continually increasing, while constraints on volume and mass continue to be present. Further, the demand for safe, low cost and environmentally friendly materials is also increasing. Although lithium-ion batteries have been developed and have demonstrated stable energies, these systems are limited by the amount of lithium that can be reversibly inserted and removed from the batteries' active material structure. As such, the requirements for greater performance, safety, low cost and environmentally friendly materials can only be achieved through the development of new battery materials, and one such material could be a negative electrode material that affords for the safe, efficient and reversible use of the electrode active material. Therefore, a material that encapsulates and prevents irreversible use of the active material, and yet allows for ionic and electronic conductivity would be desirable.

### SUMMARY OF THE INVENTION

The present invention discloses a composite material having an ionic and electronic conductive outer shell with an active material inner core located within the outer shell. The outer shell can be impervious to a gas and a liquid after the inner core material has been placed within the outer shell, and in some instances the outer shell contains a compound such as SiO₂, Al₂O₃, P₂S₅ and lithium salts, for example Li₂S. The composite material may or may not have a secondary outer shell that is located on an exterior of the outer shell such that a double-layered protective outer shell is provided. The outer shell and/or the secondary outer shell can contain a compound such as SiO₂, Al₂O₃, P₂S₅ and lithium salts, for example Li₂S. In some instances, the outer shell contains Li₂S:P₂S₅ and/or LiPON. In addition, the inner core can contain an element such as lithium, sodium, magnesium, potassium, and the like.

A battery containing the composite material can include a positive electrode, an electrolyte, and a negative electrode having a plurality of composite particles and a binding agent. The plurality of composite particles can have the ionic and electronic conductive outer shell with the active material inner core located therewithin. In addition, the negative electrode can include a conducting agent that affords for electrons to pass from particle to particle, i.e. between the plurality of composite particles.

A process for making the composite material is also included, the process including providing a hollow glass sphere and an active material and/or precursor of an active material. The active material and/or precursor of the active material and the hollow glass sphere are subjected to a processing treatment that affords for an active material inner core to form within the hollow sphere. In addition, after the active material inner core is within the outer shell of the sphere, any pores, porosity and the like that were present in the outer shell are closed or capped such that the outer shell is impervious to gases and liquids. The outer shell material can be ionically and electronically conductive and the inner core material can be electrochemically active such that electrons and ions can pass through the outer shell and electrically react with the active material inner core.

In some instances, the pores, porosity, etc., can be closed by a heat treatment, removal of a UV light, chemical treatment and the like such that such pathways collapse but the hollow spheres remains intact and does not collapse, break, etc. In other instances, the pores, porosity, etc., can be capped or covered by providing a secondary outer shell over the hollow sphere which, the secondary outer shell affording for ionic and electronic conductance therethrough.

### BRIEF DESCRIPTION OF THE DRAWINGS

FIG. 1 is a schematic illustration of a composite material according to an embodiment of the present invention;

FIG. 2 is a schematic illustration of the composite material shown in FIG. 1 with the presence of void space within an outer protective shell;

FIG. 3 is a schematic illustration of the composite material shown in FIGS. 1 and 2 with the presence of a secondary outer shell according to an embodiment of the present invention;

FIG. 4 is a schematic drawing illustrating production of a composite material according to an embodiment of the present invention;

FIG. 5 is a schematic illustration of a process according to an embodiment of the present invention;

FIG. 6 is a schematic illustration of a step for making a composite material according to a present invention;

FIG. 7 is a schematic illustration of another step for making a composite material according to an embodiment of the present invention; and

FIG. 8 is a schematic illustration of a composite material according to an embodiment of the present invention.

### DETAILED DESCRIPTION OF THE INVENTION

The present invention discloses a new material for a battery electrode that has an active material inner core with a protective outer shell that is an ionic and an electronic conductor. In addition, a process for making the material is also disclosed. As such, the new material has utility as a battery electrode material and the process has utility for making a battery electrode material.

The new battery material includes a core of active material for a negative electrode in a battery with an outer protective shell that is ionically and electronically conductive. The inner core can be made from any active material that can be used in the negative electrode of a battery, illustratively including lithium, sodium, magnesium, potassium, alloys thereof, halides thereof, hydrides thereof and the like. The outer protective shell can be made from materials such as SiO₂, Al₂O₃, P₂S₅, Li₂S and the like. In addition, the shell can be a mixture of two or more of these compounds, illustratively including Li₂S:P₂S₅.

The shell can be impervious to gases and liquids and can thereby prevent the reaction of the active material core with a surrounding environment such as air. As such, active battery materials such as lithium, sodium, potassium, etc., that are highly reactive with water, nitrogen, air, etc. can be used in a more efficient, safe and productive manner.

In some instances, a negative electrode is composed of a composite of the new material particles with the active material core within the protective impervious shell, the core-shell particles formed into an electrode using a binding agent. The electrode can have porosity for electrolyte access and the particles are micron-sized and/or smaller.

A secondary shell can optionally be present on the exterior of the shell surrounding the active material. The secondary shell can be made from similar compounds as the primary shell, and/or made from two or more of the compounds such as Li₂S:P₂S₅. If two or more compounds are used, one component can be a good electron conductor and the other a good ion conductor such as LiPON. It is appreciated that the outer shell and the secondary shell, if present, does not limit the transport of active material ions or electrons. In the case where the electroactive species shuttles between the anode and the cathode during oxidation/reduction reactions, the electroactive species does not plate on an outer surface of the outer shell or secondary shell.

One embodiment or process for providing a core-shell composite particle for a negative electrode can include providing a hollow glass sphere, the hollow glass sphere having a shell enclosing an inner volume. The wall of the hollow glass sphere may or may not be doped with metal oxides. The hollow glass sphere is placed into an enclosed chamber, such as a vacuum chamber, with the enclosed chamber evacuated until a negative pressure is present therewithin. The hollow glass sphere within the enclosed chamber is exposed to an external element, e.g. heat and/or infrared light, such that the shell affords for diffusion of atoms and/or molecules therethrough. It is appreciated that with the enclosed chamber under a negative pressure, gaseous molecules within the hollow glass sphere will seek to diffuse out of the inner volume to the surrounding enclosed chamber. In this manner, a negative pressure can be provided within the hollow glass sphere.

The process also includes providing the active material in the form of a vapor, and then exposing the evacuated enclosed chamber to the active material vapor. The active material can be in a vapor state at room temperature, a volatile liquid with a high vapor pressure at room temperature or a solid at room temperature that has been heated to provide a high vapor pressure at an elevated temperature. The active material in the enclosed chamber diffuses through the shell of the hollow glass sphere and into the inner volume. After the active material has diffused into the inner volume of the hollow glass sphere, the external element is removed from the hollow glass sphere such that diffusion of the active material through the shell is generally prohibited and the active material condenses into a condensed state. It is appreciated that the active material can be in the form of lithium, sodium, magnesium, potassium, alloys thereof, halides thereof, hydrides thereof and the like.

Another embodiment includes heating the core material such that it is in liquid form, immersing a hollow glass microsphere in the liquid core material and allowing capillary action through pores and/or porosity within the microsphere shell to afford for the core material to enter the inner volume. Thereafter, the hollow glass microsphere with the core material therewithin can be removed from the pool and/or cooled such that the core material solidifies and a desired core-shell particle is provided.

In yet another embodiment, a precursor of the core material can be at least partially dissolved in a solution and a hollow glass microsphere immersed in the solution. Again, capillary action through pores and/or porosity within the microsphere shell afford for the precursor to enter the inner volume and a subsequent treatment, e.g. a heat treatment, to the hollow glass microsphere with precursor therewithin is provided such that the precursor is converted into the final core/active material.

After the final core/active material is within the hollow glass microsphere, the pores and/or porosity that were present within wall of the microsphere are closed and/or capped using a heat treatment, removal of the external element, a chemical treatment, an electrochemical treatment or combinations thereof. In addition, a secondary outer shell exhibiting ionic and electronic conduction can be applied to the outer surface of the hollow glass microsphere. In this manner, the final core/active material is protected from contact with reactive gases and/or liquids surrounding the hollow glass microsphere, but ions and electrons can diffuse through the outer shell and/or the secondary outer shell such that the inner core can participate in a battery charge/discharge cycle.

In some instances the process can produce core-shell structured particles with an outer mean diameter of less than 50 microns. In other instances, core-shell structured particles with an outer mean diameter less than 20 micrometers can be produced, while in still other instances core-shell particles with an outer mean diameter less than 10 micrometers can be produced. In still yet other instances, core-shell structured particles with an outer mean diameter less than 5 micrometers can be produced. The average wall thickness of the outer shell for the core-shell structured particles can be less than 1 micron, less than 500 nanometers, less than 250 nanometers, less than 100 nanometers, less than 50 nanometers, and in some instances is less than 20 nanometers.

Optionally, the process produces core-shell structured particles followed by a treatment to reduce the size of the core within the outer shell. In some instances, the active material core can occupy between 5 to 99 percent of an inner volume of the outer shell and it is appreciated that a plurality of the composite core-shell structured particles can be assembled, for example with a binder, to produce an electrode.

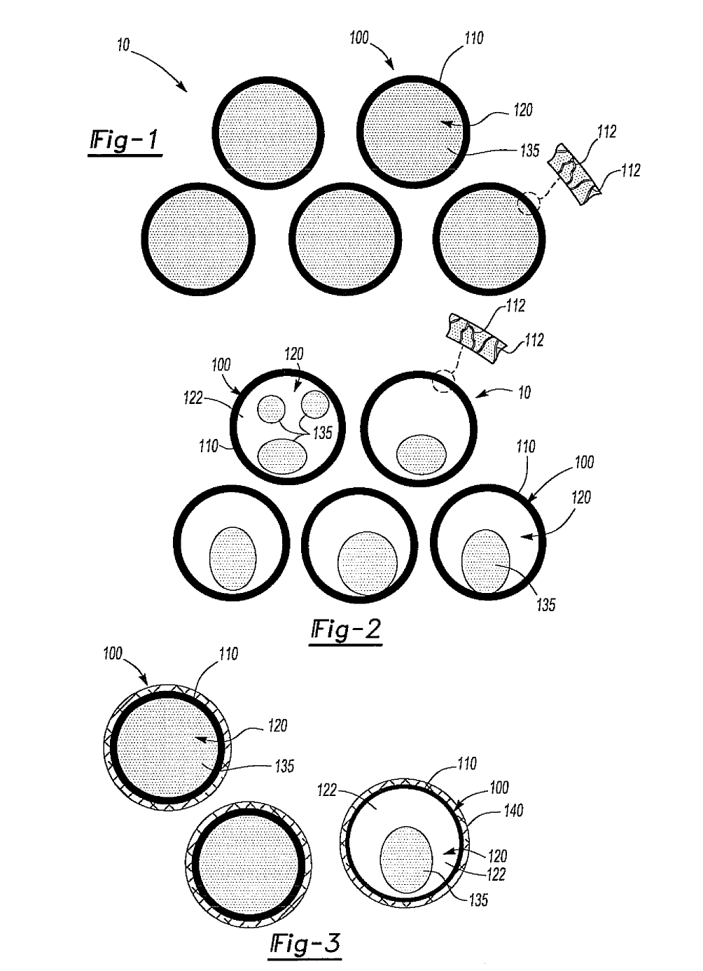

Turning now to FIGS. 1 and 2, a material made from a composite particle is shown generally at reference numeral 10. The material 10 includes a composite particle 100, the particle 100 having an outer shell 110 and an inner core 120. It is appreciated that the inner core 120 can include two separate volumes—a first volume of the core material 135 and a second volume of void space 122 (FIG. 2). In the alternative, the inner core 120 can include only one volume of the core material 135 (FIG. 1). It is also appreciated that the outer shell 110 initially has porosity 112 through which material for the inner core 135 can enter into the inner core 120 with the porosity subsequently reduced and/or removed through a post-treatment once the inner core 135 is present within the outer shell 110.

The core material 135 can be made from an active material used in the negative electrode of a battery, illustratively including lithium, sodium, magnesium, potassium and/or alloys thereof. It is appreciated that such active materials can be extremely reactive with air, water, water vapor and the like, and as such, removal of the porosity 112 from the outer shell 110 provides a barrier that is impervious to gases and/or liquids and thus protects the inner core 135 from reaction therewith.

The outer shell 110 can also be made from a variety of materials. For example, materials such as oxides, carbonates, nitrides and the like can be used to form the outer shell so long as the resulting outer shell is impervious to gases and liquids, is an electronic conductor and is also an ionic conductor. In some instances, the outer shell can be made from materials such as SiO₂, Al₂O₃, P₂S₅, Li₂S and/or mixtures of such compounds, e.g. Li₂S:P₂S₅, LiPON and the like.

Optionally, an ionically and electronically conductive secondary outer shell 140 can be present on the exterior of the outer shell 110 as shown in FIG. 3 and can be used or be present to prevent gases and liquid from coming into contact and reacting with the inner core 135. As such, the secondary outer shell 140 can be made from materials similar to the outer shell 110 and can be applied by a second process. In addition, any porosity present within the secondary outer shell 140 can be removed before the composite particle 110 is placed in use, for example, in a battery. In the alternative, the secondary outer shell 140 can be applied such that no porosity is present when the shell 140 is formed.

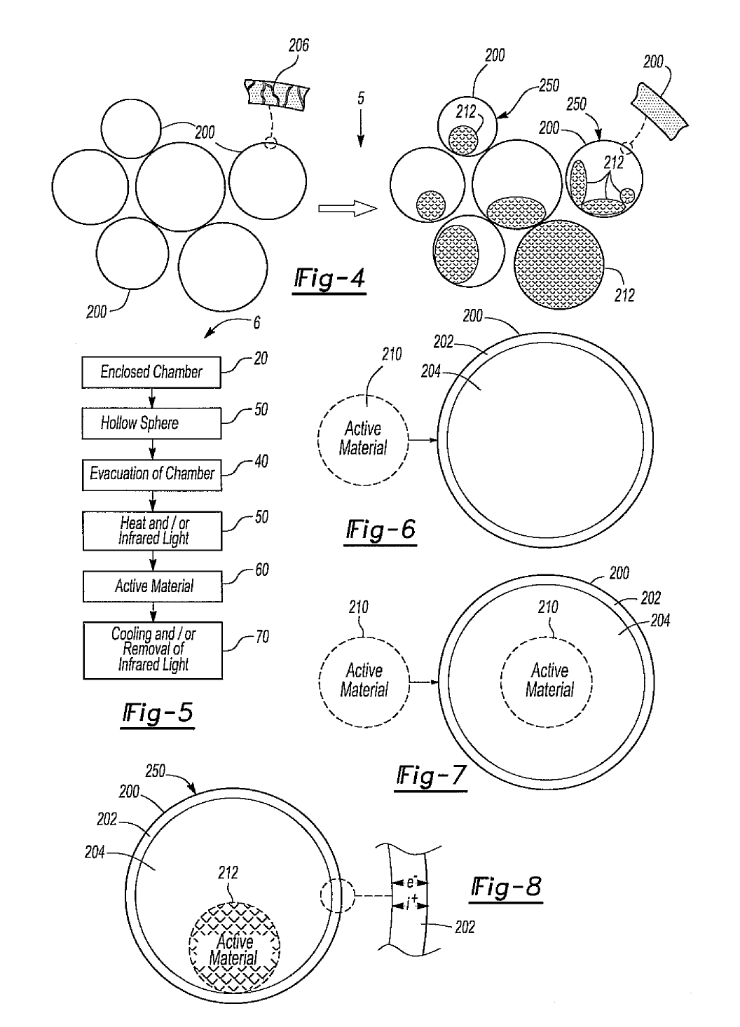

Turning now to FIG. 4, a process for making a core-shell particle is shown generally at reference numeral 5. The process 5 includes providing a hollow sphere 200 and processing the sphere 200 such that a core-shell particle 250 is provided, the particle 250 having a condensed active material 212 within the sphere 200. It is appreciated that the hollow sphere 200 has porosity 206 through which the condensed active material 212, or a precursor of the condensed active material 212, can enter the sphere 200. Either during or after the condensed active material is provided within the sphere 200, the porosity 206 is reduced and/or eliminated. In this manner, the hollow sphere 200 is impervious to gases and liquids with only electrons and ions passing through the wall of the sphere 200 and reacting with the active material 212 during use of the core-shell particle 250.

A schematic flowchart further illustrating an embodiment of a process for making a composite particle is shown generally at reference numeral 6 in FIG. 5. The process 6 can include providing an enclosed chamber at step 20. The enclosed chamber can be any chamber wherein a vacuum can be pulled thereon and is typically known as a vacuum chamber. A hollow glass sphere, and/or a hollow sphere made from any material that provides an ionically and electronically conductive outer shell is placed within the enclosed chamber at step 30. It is appreciated that a plurality of hollow spheres can be placed within the vacuum chamber, the hollow spheres made from any material, e.g. glass, that is suitable for the diffusion of the active material therethrough when an external element such as heat, infrared light, magnetic field, electrical current, and the like, is applied thereto. In some instances, the hollow glass sphere can be made from a silica based glass. In other instances, the hollow sphere will be made from metal doped silica based types of glasses.

After the hollow sphere has been placed within the enclosed chamber, the chamber is evacuated at step 40 such that a negative pressure is present therewithin. The negative pressure can be a vacuum between 10⁻³ and 10⁻⁷ torr. After the enclosed chamber has been evacuated, or in the alternative while the enclosed chamber is being evacuated, an external element is applied to the hollow sphere at step 50. As shown in FIG. 5, the external element can include the application of heat and/or infrared light upon the hollow sphere. In some instances, the application of heat to the hollow sphere results in the temperature of the sphere being between 20 and 600° C.

It is appreciated that the exposure of the hollow sphere to the external element affords for the diffusion of atoms and/or molecules through the shell of the sphere. In addition, it is appreciated that by evacuating the enclosed chamber at step 40, a pressure differential will be provided between the inner volume of the hollow sphere and the enclosed chamber surrounding the hollow sphere. As such, when the external element is provided at step 50, thereby enhancing diffusion through the shell, the pressure differential provides a driving force wherein gas atoms and/or gas molecules within the inner volume of the hollow sphere will diffuse through the shell and out into the enclosed chamber surrounding the sphere. In this manner, a negative pressure is provided within the hollow sphere.

At step 60, an active material is provided in the form of a vapor and/or liquid. In addition, one or more precursors can be provided in the form of a vapor and/or liquid. In some instances, the active material vapor can be provided by heating an active material that is in a condensed state. The active material vapor is allowed to enter the evacuated enclosed chamber, thereby resulting in an increase in pressure therewithin. With the increase in pressure within the evacuated chamber, a pressure differential is provided wherein the pressure of the active material vapor is greater outside of the hollow sphere than the pressure inside the hollow sphere, thus resulting in vapor and/or liquid diffusion through the shell of the hollow sphere into the inner volume thereof. It is appreciated that the chamber can be backfilled with an inert gas, e.g. argon, in order to reduce any reaction with the active material and/or precursor of the active material.

At a predetermined time, the external element is removed from the hollow sphere at step 70. As illustrated in FIG. 5, this can take the form of cooling the hollow sphere and/or removal of the infrared light. The removal of the external element from the hollow sphere affords for the active material vapor within the sphere to condense to a condensed state. In addition, removal of the external element can reduce or remove porosity within the shell of the hollow sphere such that the wall of the sphere is impervious to gases and liquids, and the active material within the sphere is protected from reacting with air, water, etc., when removed from the chamber 40. In the alternative, the hollow sphere with active material therewithin can be subjected to a post treatment such as a heat treatment, a chemical treatment, an electrochemical treatment and/or a secondary outer shell treatment in order to make the sphere wall impervious to gases and liquids before exposure to air, water, water vapor, etc.

Looking now at FIGS. 6-8, an illustrative example is provided for the formation of an encapsulated active material. Starting with FIG. 6, a hollow sphere 200 can have a shell 202 and an inner volume 204. After the hollow sphere 200 has been placed within an enclosed chamber and the chamber has been evacuated an active material 210 is provided. The active material 210 can be in the form of a vapor of an active inner core, a liquid of an active inner core, and/or one or more precursors of a vapor and/or liquid of an active inner core. FIG. 6 illustrates the hollow sphere 200 after the interior has been evacuated by diffusion of gas atoms and/or molecules that were within the inner volume 204 have diffused outwardly into the enclosed chamber, but before the active material 210 has diffused into the inner volume 204.

After the active material 210 is provided to the enclosed chamber, the pressure differential that is present between the exterior of the hollow sphere 200 and the inner volume 204 results in the diffusion of active material atoms and/or molecules through the shell 202 into the inner volume 204 as illustrated in FIG. 7. It is appreciated that active material atoms and/or molecules on the outer surface of the shell 202 may dissociate into different species, separately diffuse through the shell 202 and recombine to form the active material vapor on the inner surface of the shell 202. In addition, one or more precursors of the active material can diffuse through the shell 202 and form the active material once within the inner volume 204 due to a catalytic reaction within the shell 202, application of a heat treatment, a magnetic field, an electrical field and the like.

At a predetermined time, the external element that afforded for enhanced diffusion of atoms and/or molecules through the shell 202 of the hollow sphere 200 is removed and the active material 210, if in vapor form, can condense to a condensed state 212 as illustrated in FIG. 8. In addition, porosity present within the shell 202 is reduced or eliminated such the shell 202 is impervious to gases and liquids, the condensed active material 212 is protected from reacing therewith, and yet electrons and ions can diffuse through the shell 202 and afford for the material 212 to participate in electronic and ionic reactions such as those present during battery charge/discharge cycles.

In some instances, the hollow sphere 200 has an average mean diameter between 100 nanometers and 1 millimeter. In other instances, the hollow sphere 200 has an average mean diameter between 1 and 500 microns. In yet other instances, the hollow sphere 200 has an average mean diameter between 5 and 100 microns. It is appreciated that the shell 202 has a thickness. The thickness can be between 10 nanometers to 5 microns, between 10 nanometers to 1 micron, between 10 to 500 nanometers and/or between 10 to 100 nanometers.

After the external element has been removed from the hollow sphere 200, the condensed active material 212 can occupy up to at least 5% of the inner volume 204 within the hollow sphere 200 and in other instances, the condensed active material 212 occupies generally all of the inner volume 204 within the hollow sphere 200.

It is appreciated that the heat that may be provided to the hollow sphere 200 can be supplied by resistance heating, radiant heating, induction heating and the like, In addition, the infrared light can be provided by an infrared light source which is energized when so desired and deenergized when the external element is to be removed from the hollow sphere.

The invention is not restricted to the illustrative examples, embodiments and/or compositions described above. The examples, embodiments and/or compositions are not intended as limitations on the scope of the invention. As such, the specification should be interpreted broadly.

I claim:

1. A composite material comprising:
an ionic and electronic conductive outer glass shell that is impervious to a gas and a liquid;
an active material inner core located within said outer shell.

2. The composite material of claim 1, wherein said outer shell contains at least one lithium ion conducting compound selected from the group consisting of a lithium salt, SiO₂, Al₂O₃, P₂S₅ and Li₂S.

3. The composite material of claim 2, wherein said outer shell contains Li₂S:P₂S₅.

4. The composite material of claim 2, wherein said outer shell contains LiPON.

5. The composite material of claim 1, further comprising a secondary outer shell on an exterior of said outer shell.

6. The composite material of claim 5, wherein said secondary outer shell contains a compound selected from the group consisting of SiO₂, Al₂O₃, P₂S₅ and Li₂S.

7. The composite material of claim 6, wherein said secondary outer shell contains Li₂S:P₂S₅.

8. The composite material of claim 6, wherein said secondary outer shell contains LiPON.

9. The composite material of claim 1, wherein said inner core contains an element selected from the group consisting of lithium, sodium, magnesium and potassium.

10. A battery comprising:
a positive electrode;
an electrolyte;
a negative electrode having a plurality of composite particles and a binding agent;
said plurality of composite particles having an ionic and electronic conductive outer shell and an active material inner core located within said outer shell.

11. The battery of claim 10, wherein said outer shell contains at least one lithium ion conducting compound selected from the group consisting of a lithium salt, SiO₂, Al₂O₃, P₂S₅ and Li₂S.

12. The battery of claim 11, wherein said outer shell contains Li₂S:P₂S₅.

13. The battery of claim 11, wherein said outer shell contains LiPON.

14. The battery of claim 10, further comprising a secondary outer shell on an exterior of said outer shell.

15. The battery of claim 14, wherein said secondary outer shell contains a compound selected from the group consisting of SiO₂, Al₂O₃, P₂S₅ and Li₂S.

16. The battery of claim 15, wherein said secondary outer shell contains Li₂S:P₂S₅.

17. The battery of claim 15, wherein said secondary outer shell contains LiPON.

18. The battery of claim 10, wherein said inner core contains an element selected from a group consisting of lithium, sodium, magnesium and potassium.

19. The battery of claim 10, further comprising said negative electrode having a conducting agent operable for electrons to travel between said plurality of composite particles.
